(19) United States
(12) Patent Application Publication
(10) Pub. No.: US 2005/0111019 A1
(43) Pub. Date: May 26, 2005

(54) Color image processing method and color image processing system

(75) Inventors: Shigeki Nakauchi, Aichi (JP); Yoshiki Nakano, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toyo Ink Mfg. Co., Ltd., Tokyo (JP)

(21) Appl. No.: 10/991,428

(22) Filed: Nov. 19, 2004

(30) Foreign Application Priority Data
Nov. 21, 2003 (JP) 2003-392021
Dec. 2, 2003 (JP) 2003-402649
Dec. 19, 2003 (JP) 2003-421903
Dec. 26, 2003 (JP) 2003-431744

(51) Int. Cl. G06F 15/00; G06K 15/00

(52) U.S. Cl. 358/1.9; 358/3.1

(57) ABSTRACT

A combination of colors that can be distinguished by a person of normal color vision but cannot be distinguished by a color-deficient person in an arbitrary color image is detected on the basis of a parameter for determining the combination of colors that can be distinguished by the person of normal color vision but cannot be distinguished by the color-deficient person. One of colors of the detected combination is changed to a specific color and the resultant image is displayed as a warning image. Alternately, one of colors of the detected combination is corrected and the resultant image is displayed as a corrected image.

### CROSS REFERENCE TO RELATED APPLICATION

This application claims benefit of priority under 35 U.S.C. §119 to Japanese Patent Applications No. 2003-392021, filed on Nov. 21, 2003; No. 2003-402649, filed on Dec. 2, 2003; No. 2003-421903, filed on Dec. 19, 2003; and No. 2003-431744, filed on Dec. 26, 2003, the entire contents of which are incorporated by reference herein.

### BACKGROUND OF THE INVENTION

1. Technical Field

The present invention relates to a color image processing method and a color image processing system and, more particularly, to a color image processing method and a color image processing system for generating an image that warns of an arrangement of colors which a color-deficient person tends to confuse, in an arbitrary color image.

The invention relates to a color image processing method and a color image processing system and, more particularly, to a color image processing method and a color image processing system for correcting an assignment of colors which a color-deficient person tends to confuse, in an arbitrary color image while holding a way in which the image is seen by a person of normal color vision.

2. Description of the Related Art

Various printed matters and indications around us are full of colors and provide a large amount of information by expressing characters and images in colors. Proliferation of various digital color devices in recent years makes the user feel closer to the full-color world. For example, the Internet is one of the most popular information providing means and the importance of color information among the information is increasing.

Meanwhile, color deficiency or dyschromatopsia occurs one in 20 Japanese men and one in 12 white men. It is reported in many documents that the color deficiency occurs when a person sees colors by using two photoreceptor cells remaining due to some mutation among three visual pigment genes of blue, red, and green. Although people having color deficiency or dyschromatopsia can differentiate colors in a considerably wide range, they confuse some colors. They cannot grasp the provided various color information, or they recognize the color information erroneously.

Under present circumstances, attempts are made as follows so that a color-deficient person can also easily differentiate colors. In printing designing and screen designing, to make a color design so that a color-deficient person can also recognize colors like a person of normal color vision, corrections are made by trial and error on the basis of experiments and psychologically proved results. Since increase in the cost of taking a special measure accompanies, in many cases, sufficient consideration is not given to color-deficient persons. As conventional image color converting techniques for color-deficient persons, “color video signal converting apparatus” (Japanese Patent Application Laid-open (JP-A) No. 2002-44678), “color converting apparatus” (JP-A No. 63-282883), “image processing apparatus” (JP-A No. 8-16129), “display system for color-deficient persons” (JP-A No. 11-175050), and the like have been proposed. As color converting means, means for performing a process of rimming only a border between neighboring colors, means of using a color conversion table, means of changing brightness or saturation, and the like are described, however, none of those methods is disclosed a method for concretely converting a color. In addition, those techniques do not consider holding of a design concept of an image, so that conversion of a hue is not mentioned. Further, the techniques do not include colors close to colors that are recognized by a color-deficient person, so that sufficient corrections are not made or efficient conversion is not realized.

### SUMMARY OF THE INVENTION

The present invention has been achieved in consideration of the above points and its object is to provide a color image processing method and a color image processing system for generating an image that warns of an arrangement of colors which a color-deficient person tends to confuse, in an arbitrary color image.

Further, the present invention has been achieved in consideration of the above points and its object is to provide a color image processing method and a color image processing system for correcting an assignment of colors which a color-deficient person tends to confuse, in an arbitrary color image while holding a way in which the image is seen by a person of normal color vision.

To achieve the object, there is provided a color image processing method comprising the steps of: detecting a combination of colors that can be distinguished by a person of normal color vision but cannot be distinguished by a color-deficient person in an arbitrary color image on the basis of a parameter for determining a combination of colors that can be distinguished by the person of normal color vision but cannot be distinguished by the color-deficient person; and displaying, as a warning image, an image obtained by changing one of colors of the detected combination into a specific color.

In a preferred embodiment of the invention, the color image processing method further comprises the steps of: clustering colors in the arbitrary color image into a plurality of color groups; counting the number of pixels having a color to be changed into the specific color in each cluster; and setting all of colors in a cluster having a predetermined ratio or higher of the number of the pixels as objects to be changed to the specific color.

To achieve the object, there is provided a color image processing method comprising the steps of: detecting a combination of colors that can be distinguished by a person of normal color vision but cannot be distinguished by a color-deficient person in an arbitrary color image on the basis of a parameter for determining a combination of colors that can be distinguished by the person of normal color vision but cannot be distinguished by the color-deficient person; and displaying, as a corrected image, an image obtained by correcting one of colors of the detected combination.

In a preferred embodiment of the invention, the correction is made in consideration of the degree to which the color-deficient person confuses the detected combination of colors and the degree to which one of the colors of the detected combination is corrected.

In a preferred embodiment of the invention, the correction is made so as to minimize the sum of the degree to which the color-deficient person confuses the detected combination of colors and the degree to which one of the colors of the detected combination is corrected.

In a preferred embodiment of the invention, the color image processing method further comprises the steps of: clustering colors in the arbitrary image into a plurality of color groups; counting the number of pixels having a color to be corrected in each cluster; and setting all of colors in a cluster having a predetermined ratio or higher of the number of the pixels as objects of the correction.

In a preferred embodiment of the invention, when the displayed image is not a desired one, the parameter is corrected.

To achieve the object, there is provided a color image processing method comprising the steps of: presenting a color image to color-deficient persons; deriving respective parameters for determining a combination of colors that can be distinguished by a person in normal color vision but cannot be distinguished by a color-deficient person by obtaining data regarding a way the color image is seen by the respective color-deficient persons; detecting the combination of colors that can be distinguished by the person in normal color vision but cannot be distinguished by the color-deficient person in an arbitrary color image on the basis of each parameter; and displaying, as a warning image, an image obtained by changing one of colors of the detected combination into a specific color to each color-deficient person.

In a preferred embodiment of the invention, the color image processing method further comprises the steps of: clustering colors in the arbitrary color image into a plurality of color groups; counting the number of pixels having a color to be changed into the specific color in each cluster; and setting all of colors in a cluster having a predetermined ratio or higher of the number of the pixels as objects to be changed into the specific color.

In a preferred embodiment of the invention, each parameter is derived by presenting a plurality of color images to each color-deficient person and obtaining data regarding ways the plurality of color images are seen by each color-deficient person.

To achieve the object, there is provided a color image processing method comprising the steps of: presenting a color image to color-deficient persons; deriving respective parameters for determining a combination of colors that can be distinguished by a person in normal color vision but cannot be distinguished by a color-deficient person by obtaining data regarding a way the color image is seen by the respective color-deficient persons; detecting the combination of colors that can be distinguished by the person in normal color vision but cannot be distinguished by the color-deficient person in an arbitrary color image on the basis of each parameter; and displaying, as a corrected image, an image obtained by correcting one of colors of the detected combination to each color-deficient person.

In a preferred embodiment of the invention, the correction is made in consideration of the degree to which the color-deficient person confuses the detected combination of colors and the degree to which one of the colors of the detected combination is corrected.

In a preferred embodiment of the invention, the correction is made so as to minimize the sum of the degree to which the color-deficient person confuses the detected combination of colors and the degree to which one of the colors of the detected combination is corrected.

In a preferred embodiment of the invention, the color image processing method further comprises the steps of: clustering colors in the arbitrary image into a plurality of color groups; counting the number of pixels having a color to be corrected in each cluster; and setting all of colors in a cluster having a predetermined ratio or higher of the number of the pixels as objects of the correction.

In a preferred embodiment of the invention, each parameter is derived by presenting a plurality of color images to each color-deficient person and obtaining data regarding ways the plurality of color images are seen by each color-deficient person.

To achieve the object, there is provided a color image processing system comprising: an input unit which receives a parameter for determining a combination of colors that can be distinguished by a person of normal color vision but cannot be distinguished by a color-deficient person, and an arbitrary color image; a color warning control unit which detects the combination of colors that can be distinguished by the person of normal color vision but cannot be distinguished by the color-deficient person in the arbitrary color image on the basis of the parameter and changes one of colors of the detected combination into a specific color; and a display which displays, as a warning image, an image obtained by changing one of the colors of the detected combination into the specific color.

In a preferred embodiment of the invention, the color warning control unit clusters colors in the arbitrary color image into a plurality of color groups, counts the number of pixels having a color to be changed into the specific color in each cluster, and sets all of colors in a cluster having a predetermined ratio or higher of the number of the pixels as objects to be changed into the specific color.

To achieve the object, there is provided a color image processing system comprising: an input unit which receives a parameter for determining a combination of colors that can be distinguished by a person of normal color vision but cannot be distinguished by a color-deficient person, and an arbitrary color image; a color correction control unit which detects the combination of colors that can be distinguished by the person of normal color vision but cannot be distinguished by the color-deficient person in the arbitrary color image on the basis of the parameter and corrects one of colors of the detected combination; and a display which displays, as a corrected image, an image obtained by correcting one of the colors of the detected combination.

In a preferred embodiment of the invention, the color correction control unit makes the correction in consideration of the degree to which the color-deficient person confuses the detected combination of colors and the degree to which one of the colors of the detected combination is corrected.

In a preferred embodiment of the invention, the color correction control unit makes the correction so as to minimize the sum of the degree to which the color-deficient person confuses the detected combination of colors and the degree to which one of the colors of the detected combination is corrected.

In a preferred embodiment of the invention, the color correction control unit clusters colors in the arbitrary image into a plurality of color groups, counts the number of pixels having a color to be corrected in each cluster; and sets all of colors in a cluster having a predetermined ratio or higher of the number of the pixels as objects of the correction.

To achieve the object, there is provided a color image processing system comprising: a display which displays a color image to color-deficient persons; a parameter control unit which derives respective parameters for determining a combination of colors that can be distinguished by a person in normal color vision but cannot be distinguished by a color-deficient person by obtaining data regarding a way the color image is seen by the respective color-deficient persons; and a color warning control unit which detects the combination of colors that can be distinguished by the person in normal color vision but cannot be distinguished by the color-deficient person in an arbitrary color image on the basis of each parameter and changes one of colors of the detected combination into a specific color, wherein a color image obtained by changing one of the colors of detected combination into the specific color is displayed as a warning image on the display.

In a preferred embodiment of the invention, the color warning control unit clusters colors in the arbitrary color image into a plurality of color groups, counts the number of pixels having a color to be changed into the specific color in each cluster, and sets all of colors in a cluster having a predetermined ratio or higher of the number of the pixels as objects to be changed into the specific color.

To achieve the object, there is provided a color image processing system comprising: a display which displays a color image to color-deficient persons; a parameter control unit which derives respective parameters for determining a combination of colors that can be distinguished by a person in normal color vision but cannot be distinguished by a color-deficient person by obtaining data regarding a way the color image is seen by the respective color-deficient persons; and a color correction control unit which detects the combination of colors that can be distinguished by the person in normal color vision but cannot be distinguished by the color-deficient person in an arbitrary color image on the basis of each parameter and corrects one of colors of the detected combination, wherein a color image obtained by correcting one of the colors of the detected combination is displayed as a corrected image on the display.

In a preferred embodiment of the invention, the color correction control unit makes the correction in consideration of the degree to which the color-deficient person confuses the detected combination of colors and the degree to which one of the colors of the detected combination is corrected.

In a preferred embodiment of the invention, the color correction control unit makes the correction so as to minimize the sum of the degree to which the color-deficient person confuses the detected combination of colors and the degree to which one of the colors of the detected combination is corrected.

In a preferred embodiment of the invention, the color correction control unit clusters colors in the arbitrary image into a plurality of color groups, counts the number of pixels having a color to be corrected in each cluster, and sets all of colors in a cluster having a predetermined ratio or higher of the number of the pixels as objects of the correction.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a diagram showing the configuration of a color processing system according to a first embodiment;

FIG. 2 is a flowchart showing the procedure of the color processing system according to the first embodiment;

FIG. 3 is a conceptual diagram showing detection of colors which cannot be easily distinguished from each other by a color-deficient person;

FIG. 4 is a conceptual diagram showing color clustering of an image;

FIG. 5 is a conceptual diagram showing determination of a cluster to be corrected;

FIG. 6 is a diagram showing an LMS space indicative of response of photoreceptor cells of a human to colors;

FIG. 7 is a diagram showing the configuration of a color processing system according to a second embodiment; and

FIG. 8 is a flowchart showing the procedure of the color processing system according to the second embodiment.

### DESCRIPTION OF THE PREFERRED EMBODIMENTS

Embodiments of the invention will be described in detail hereinbelow with reference to the drawings.

First, dyschromatopsia referred to as a precondition in the invention will be described. Dyschromatopsia is roughly divided into three kinds; cone monochromatism (which occurs in 0.01% or less of the population) where only one kind of cone photopigments of eyes functions, dichromatism (which occurs in about 1.5% of men) where a person has only two functioning cone photopigments, and anomalous trichromatism (which occurs in about 3.5% of men) which is a shift in the wavelength characteristic of one of the three kinds of photopigments. The dichromatism and anomalous trichromatism are sub-divided into protanomalous, deuteranomalous, and tritanomalous in accordance with a cone in which a deficiency occurs. In the protanomalous and deuteranomalous, the ways colors are seen are relatively close to each other. Consequently, protanomalous and deuteranomalous are generically called “red-green blindness”. Tritanomalous is rare.

The basic idea of the invention will now be described. The basic idea of the invention is that a combination of two colors which are thought to be erroneously recognized is detected on the basis of color difference in a space of a color-deficient person when the colors having the color difference in a color space of a person of normal color vision are move to the space of a color-deficient person. The color whose frequency in appearing in an image is lower in the combination of colors is set as a risk color, and colors close to the risk color are clarified as a risk color group (cluster). By changing only the colors in the risk color group so as to reduce the degree of risk in accordance with an evaluation function, color correction is efficiently made.

A risk color detector used in the invention converts a color difference recognized by a person having no color deficiency into a color difference recognized by a color deficient person and makes determination in accordance with a preset threshold.

An evaluation function used in the invention is specified by the sum of the degree of confusion indicated by the color difference in the color space recognized by the color deficient person and the degree of change expressed by the color difference between a corrected color and a color before correction in the color space recognized by the person having no color deficiency, and the color to be corrected is corrected so as to minimize the evaluation function.

### First Embodiment

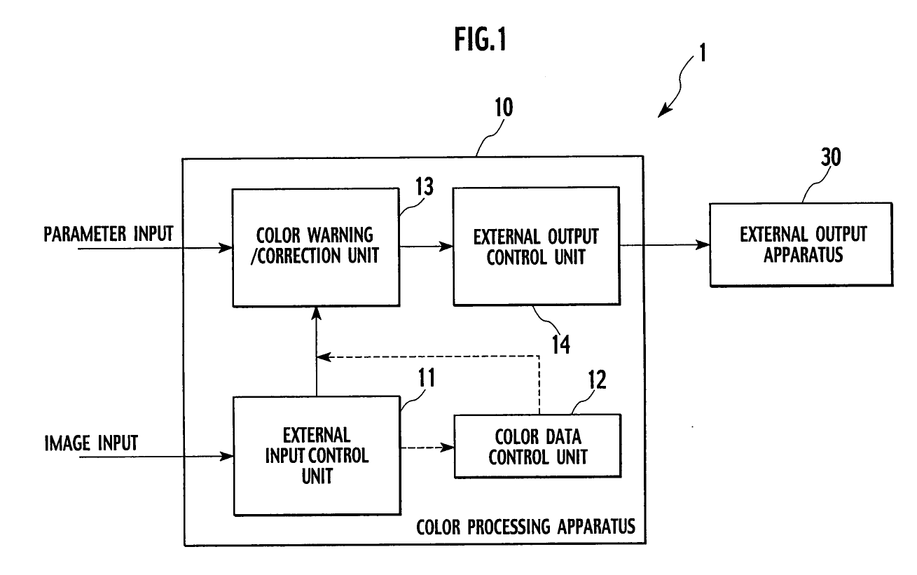

A first embodiment of a color processing system of the invention will be described hereinbelow with reference to FIGS. 1 to 6.

FIG. 1 is a diagram showing the configuration of the color processing system according to the first embodiment.

A color processing system 1 according to the first embodiment is constructed by a color processing apparatus 10 and an external output apparatus 30 such as an image displaying apparatus or printer. The color processing apparatus 10 has: an external input control unit 11 to which image data is input; a color data control unit 12 for converting input image data to a color value when the input image data is not a color value; a color warning/correction control unit 13 which receives image data, detects a risk color in the image data, warns of the detected risk color, and corrects the detected risk color (including colors in a selected cluster in the case where a cluster process is performed); and an external output control unit 14 for performing a predetermined process on image data which is input from the color warning/correction control unit 13 and outputting the processed image data to the external output apparatus 30.

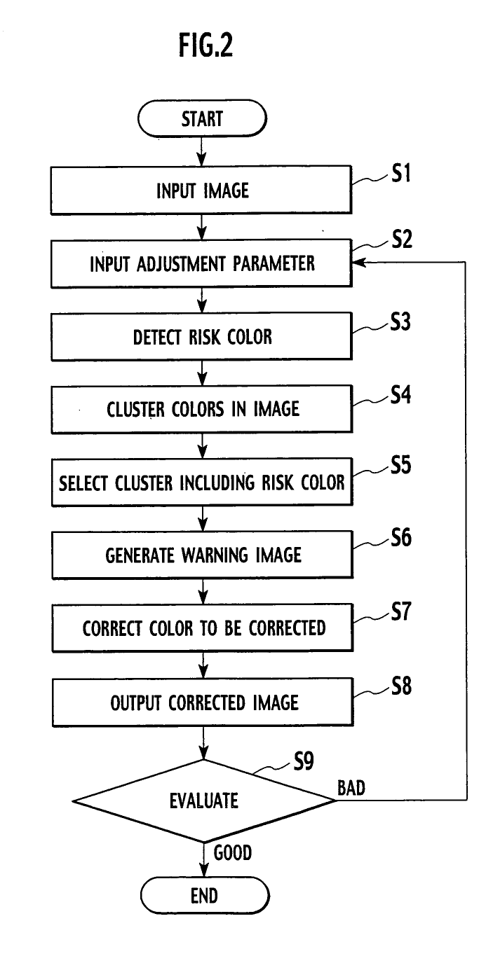

FIG. 2 is a flowchart showing the procedure of the color processing system according to the first embodiment.

First, image data taking the form of a color data, RGB value, CMYK value or the like as an object to be converted is input to the external input control unit 11 in the color processing apparatus 10 (step S1). The image data input to the external input control unit 11 is sent to the color warning/correction control unit 13. In the case where the image data is not a color value, the image data is sent to the color data control unit 12 where it is converted to a color value. After that, the color value is sent to the color warning/correction control unit 13. The image data which is input to the color warning/correction control unit 13 is sent to the external output control unit 14 and an image of the image data is output from the external output apparatus 30.

Next, parameters for adjustment as necessary are input to the color warning/correction control unit 13 in the color processing apparatus 10 (step S2). The parameters are adjustment parameters for displaying a color which is not easily recognized by a color deficient as a warning color and express, for example, a ratio between a color difference recognized by a color deficient and a color difference recognized by a person having no color deficient, a color difference which cannot be recognized even by a person having no color deficiency, and a color difference which can be sufficiently recognized also by a color deficient. As soon as measurement data indicating how a color deficient sees color is obtained in future, the parameters can be replaced with the measurement data.

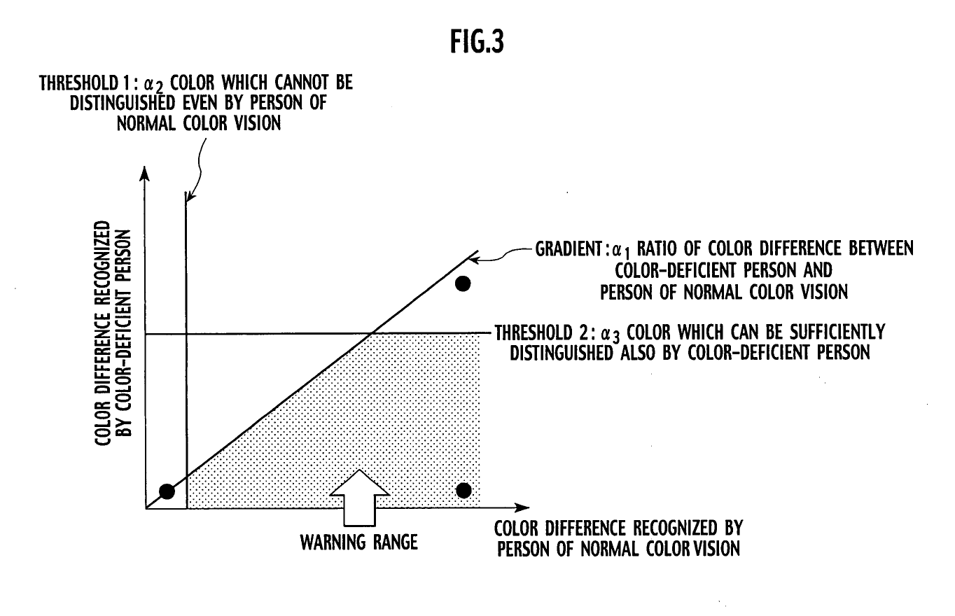

The color warning/correction control unit 13 scans the input image and determines whether or not the input image includes a combination of colors which a color-deficient person tends to confuse. Concretely, in the process, first, a combination of colors which cannot be distinguished even by a person having normal color vision and a combination of colors which can be sufficiently distinguished also by a color-deficient person are excluded and the ratio between the color difference recognized by a color-deficient person and the color difference recognized by a person of normal color vision is controlled with the parameters, thereby detecting a combination of colors which a color-deficient person tends to confuse. FIG. 3 shows the concept of the method. In the combination of colors which a color-deficient person tends to confuse, for example, a color in a smaller range is selected as a risk color (step S3).

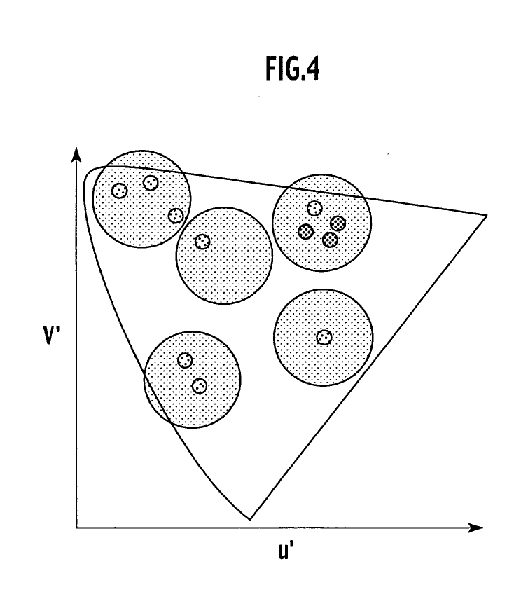

The color warning/correction control unit 13 performs clustering for classifying colors used in an input original image into a plurality of color groups (step S4). Steps S4 and S5 are not essential in the invention but are recommended to obtain a natural corrected image. FIG. 4 shows the concept of the clustering.

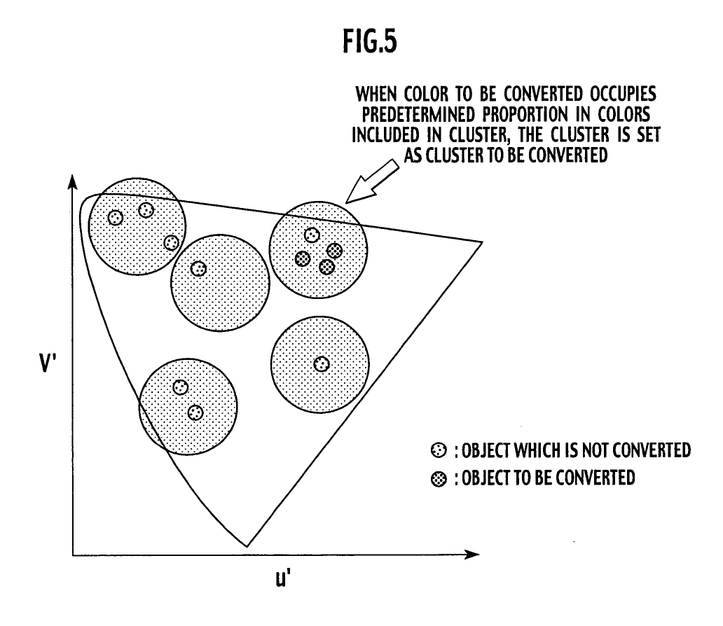

The color warning/correction control unit 13 selects some of color groups (clusters) obtained in step S4 including the risk color detected in step S3 (step S5). In the selection, as shown in FIG. 5, a cluster having a predetermined ratio or higher of the number of pixels having the risk color to be corrected (for example, the half or more) is selected as an object to be corrected. Colors close to the risk color are also selected as objects to be corrected by the clustering process, thereby obtaining a more natural corrected image.

After that, the color warning/correction control unit 13 converts the image and thus generates a warning image in which the color in the cluster to be corrected can be identified (step S6). For example, by changing the color in the cluster to be corrected into black or any other specific color, a warning image is generated. When the color warning/correction control unit 13 outputs the warning image to the external output control unit 14, the warning image can be displayed or printed in the external output apparatus 30, so that the user can recognize the object to be corrected prior to correction.

Next, the color warning/correction control unit 13 corrects the color to be corrected obtained in step S6 (in the case where steps S4 and S5 are not performed, the risk color) (step S7).

In the invention, in the color correction, both of the degree that a color-deficient person confuses after the correction and the degree of correcting the color are considered. Specifically, color correction is made so as to minimize the sum of the degree that a color-deficient person confuses after the correction and the degree of correcting color.

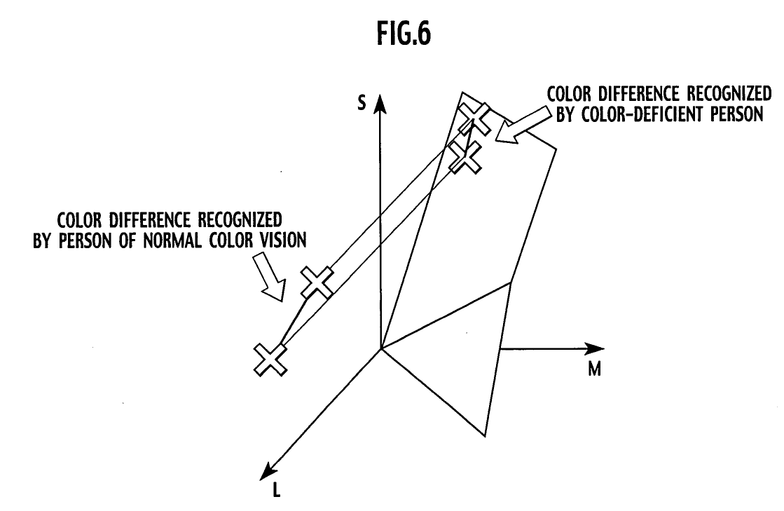

FIG. 6 shows an LMS space showing response of a photoreceptor cell of a human to colors, and indicates the color difference in a combination of two colors recognized by a person of normal color vision and the color difference in the two colors recognized by a color-deficient person.

First, the degree of confusion of a color Cᵢ is defined, for example, as Equation (1) on the basis of a distance between the color Cᵢ and another color Cₖ in a color space such as the CIELUV uniform color space. The larger the value of Equation (1) is, the higher the degree of confusion is.

$${φ}_{1} ( Ci ) = {\sum }_{k = 1}^{} \frac{1}{‖ {C}_{i} - {C}_{k} ‖ + δ} \qquad ( 1 )$$

Next, the degree of change in the color Cᵢ is defined, for example, as Equation (2) on the basis of a distance between the color Cᵢ and a color Cₒ before change in the color space such as the CIELUV uniform color space. The larger the value of Equation (2) is, the higher the degree of change is.

$${φ}_{2} ( {C}_{i} ) = \frac{1}{2} λ ‖ {C}_{i} - {C}_{i}^{0} ‖ \qquad ( 2 )$$

The color warning/correction control unit 13 makes color correction on the color Cᵢ so that the sum of Equations (1) and (2) becomes the minimum.

$$φ ( {C}_{i} ) = {\sum }_{k = 1}^{} \frac{1}{‖ {C}_{i} - {C}_{k} ‖ + δ} + \frac{1}{2} λ ‖ {C}_{i} - {C}_{i}^{0} ‖ \qquad ( 3 )$$

At the time of changing or updating the color to be corrected so as to minimize the equation (3), any of various known calculating methods such as the steepest descent method and random search method can be used.

The color warning/correction control unit 13 outputs the image corrected in step S7 to the external output control unit 14 and the corrected image is displayed or printed in the external output apparatus 30 (step S8). Finally, the corrected image is recognized and evaluated (step S9). According to the result of evaluation, the program can return to step S2 where the parameters are controlled again and adjustment can be made repeatedly.

As the color correction in step S7, the known color converting technique described in Background of the Invention may be used. However, it is to be noted that an object to be corrected is only a color in a cluster to be corrected.

Alternately, the color processing system may just display or print a warning image by the external output apparatus 30 without making the color correction.

### Second Embodiment

A second embodiment of the color processing system of the invention will now be described. In the first embodiment, the color processing system is constructed by setting adjustment parameters (and making a correction as necessary) with a typical color-deficient person in mind. In the second embodiment, a color processing system which is adapted to each of color-deficient persons by setting adjustment parameters peculiar to each of the color-deficient persons is provided. In particular, in the second embodiment, a color processing system which is adapted to each of color-deficient persons is provided in such a manner that a process server and a terminal for an observer are connected to each other via a network, and a color-deficient person evaluates an image sent from the process server on an output apparatus such as a monitor of the terminal for an observer and answers questions. On the basis of the answers, the process server sets parameters adapted to the color-deficient person. In the following, only the configurations and processes different from those of the first embodiment will be described and description of common parts will not be repeated.

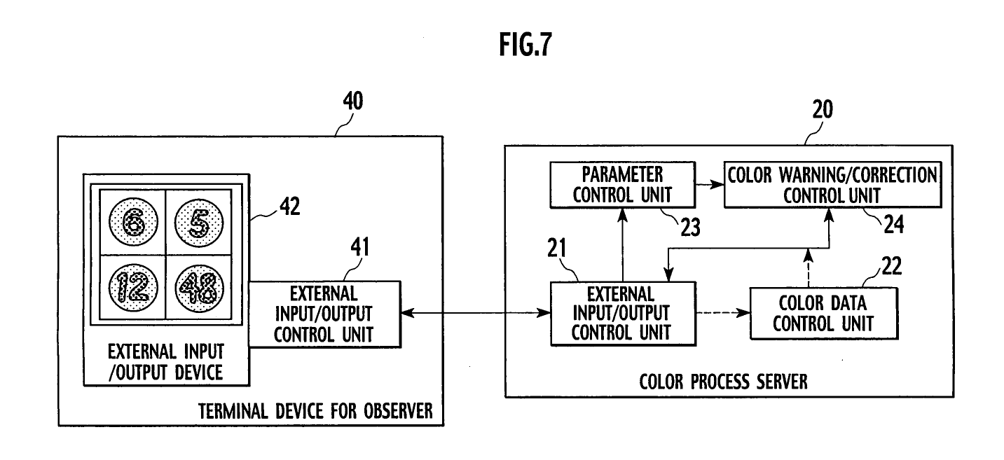

FIG. 7 is a diagram showing the configuration of the color processing system according to the second embodiment.

The color processing system 1 according to the second embodiment is constructed by a color process server 20 and a terminal device 40 for an observer. The color process server 20 has: an external input/output control unit 21 for transmitting image data to the terminal device 40 for an observer and receiving image evaluation data from the terminal device 40 for an observer; a color data control unit 22 for converting the image data to a color value when the image data is not a color value; a parameter control unit 23 for setting parameters for adjustment on the basis of the image evaluation data supplied from the external input/output control unit 21; and a color warning/correction control unit 24 for receiving the image data, detecting a risk color in the image data, warning the user of the detected risk color, and correcting the detected risk color (including a color in a selected cluster in the case where a clustering process is performed). The terminal device 40 for an observer has an external input/output control unit 41 for controlling input/output of data, and an external input/output device 42 for displaying an image and receiving data from an observer.

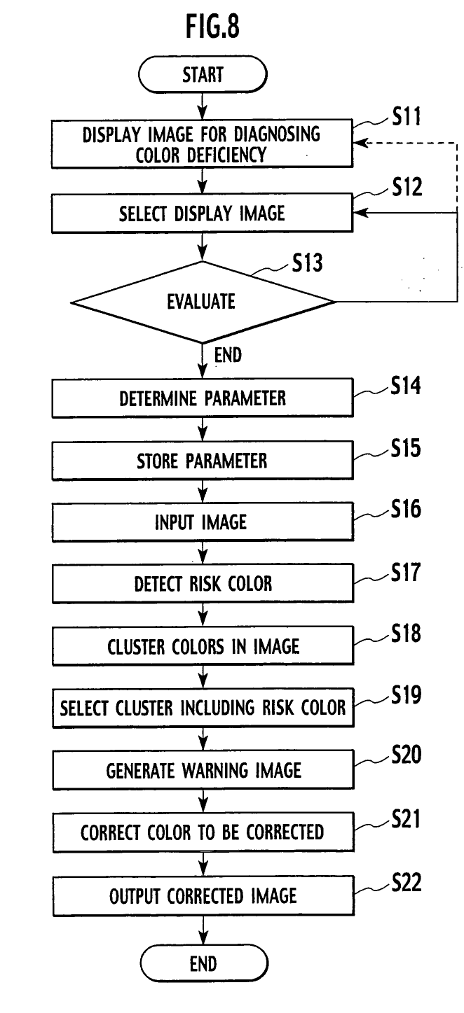

FIG. 8 is a flowchart showing procedure of the color processing system according to the second embodiment.

In the second embodiment, to set parameters adapted to each of color-deficient persons, first, the system makes an observer evaluate image data constructed by an RGB value, a CMYK value, or the like for diagnosing color deficiency on a monitor or the like. To be specific, a plurality of images for diagnosing color deficiency are transmitted from the color process server 20 connected via a network to the terminal device 40 for an observer and displayed on a monitor included in the external input/output device 42 or the like (step S11). It is preferable to preliminarily make color adjustment in the monitor or the like used.

The observer selects one of the plurality of displayed images for diagnosing color deficiency (step S12). The observer evaluates the selected image by answering questions (step S13). Evaluation data input by the observer is transmitted to the color process server 20 via the external input/output control unit 41. The evaluation data received by the color process server 20 is input to the parameter control unit 23 via the external input/output control unit 21. The parameter control unit 23 sets parameters for adjustment on the basis of the evaluation data. The observer selects another image and evaluates the selected another image. The color process server 20 updates the parameters for adjustment on the basis of the evaluation. The series of processes is performed on all of images displayed on the monitor. In the case where there are images which are not displayed yet, the images are similarly displayed and subjected to the processes.

After completion of the processes on all of the images, the parameter control unit 23 of the color process server 20 determines final parameters for adjustment (step S14). In such a manner, the parameters for adjustment according to the symptom of the color deficiency of the observer are set. The parameters for adjustment finally determined are stored together with an identification code of the observer in a not-shown memory in the color process server 20 (step S15).

The parameters are adjustment parameters for displaying a color which is not easily recognized by a color-deficient person as a warning color in a manner similar to the first embodiment and are, for example, the ratio between the color difference recognized by a color-deficient person and the color difference recognized by a person of normal color vision, a color difference which cannot be recognized even by a person of normal color vision, and a color difference which can be sufficiently recognized also by a color-deficient person.

An image desired to be processed is supplied from the observer or an image generator such as a designer to the color process server 20 via a network (step S16). At this time, on the basis of the identification code of the color-deficient person observing the image, parameters for adjustment corresponding to the observer is selected.

Processes in steps S17 to S22 are similar to the processes in steps S3 to S8 in the first embodiment.

In the second embodiment, data such as image data is transmitted/received via a network. The invention is not limited to the embodiment, and data may be transmitted/received indirectly via a recording medium. Although the embodiment has been described that the color process server and the terminal device for an observer are separate members, the color process server and the terminal device for an observer may be a physically integrated device.

More generally, it should be understood that many modifications and adaptations of the invention will become apparent to those skilled in the art and it is intended to encompass such obvious modifications and changes in the scope of the claims appended hereto.

1. A color image processing method comprising the steps of:
detecting a combination of colors that can be distinguished by a person of normal color vision but cannot be distinguished by a color-deficient person in an arbitrary color image on the basis of a parameter for determining a combination of colors that can be distinguished by the person of normal color vision but cannot be distinguished by the color-deficient person; and
displaying, as a warning image, an image obtained by changing one of colors of the detected combination into a specific color.

2. The color image processing method according to claim 1, further comprising the steps of:
clustering colors in the arbitrary color image into a plurality of color groups;
counting the number of pixels having a color to be changed into the specific color in each cluster; and
setting all of colors in a cluster having a predetermined ratio or higher of the number of the pixels as objects to be changed to the specific color.

3. A color image processing method comprising the steps of:
detecting a combination of colors that can be distinguished by a person of normal color vision but cannot be distinguished by a color-deficient person in an arbitrary color image on the basis of a parameter for determining a combination of colors that can be distinguished by the person of normal color vision but cannot be distinguished by the color-deficient person; and
displaying, as a corrected image, an image obtained by correcting one of colors of the detected combination.

4. The color image processing method according to claim 3, wherein said correction is made in consideration of the degree to which the color-deficient person confuses the detected combination of colors and the degree to which one of the colors of the detected combination is corrected.

5. The color image processing method according to claim 4, wherein said correction is made so as to minimize the sum of the degree to which the color-deficient person confuses the detected combination of colors and the degree to which one of the colors of the detected combination is corrected.

6. The color image processing method according to claim 3, further comprising the steps of:
clustering colors in the arbitrary image into a plurality of color groups;
counting the number of pixels having a color to be corrected in each cluster; and
setting all of colors in a cluster having a predetermined ratio or higher of the number of the pixels as objects of said correction.

7. The color image processing method according to claim 3, wherein when the displayed image is not a desired one, the parameter is corrected.

8. A color image processing method comprising the steps of:
presenting a color image to color-deficient persons;
deriving respective parameters for determining a combination of colors that can be distinguished by a person in normal color vision but cannot be distinguished by a color-deficient person by obtaining data regarding a way the color image is seen by the respective color-deficient persons;
detecting the combination of colors that can be distinguished by the person in normal color vision but cannot be distinguished by the color-deficient person in an arbitrary color image on the basis of each parameter; and
displaying, as a warning image, an image obtained by changing one of colors of the detected combination into a specific color to each color-deficient person.

9. The color image processing method according to claim 8, further comprising the steps of:
clustering colors in the arbitrary color image into a plurality of color groups;
counting the number of pixels having a color to be changed into the specific color in each cluster; and
setting all of colors in a cluster having a predetermined ratio or higher of the number of the pixels as objects to be changed into the specific color.

10. The color image processing method according to claim 8, wherein each parameter is derived by presenting a plurality of color images to each color-deficient person and obtaining data regarding ways the plurality of color images are seen by each color-deficient person.

11. A color image processing method comprising the steps of:
presenting a color image to color-deficient persons;
deriving respective parameters for determining a combination of colors that can be distinguished by a person in normal color vision but cannot be distinguished by a color-deficient person by obtaining data regarding a way the color image is seen by the respective color-deficient persons;
detecting the combination of colors that can be distinguished by the person in normal color vision but cannot be distinguished by the color-deficient person in an arbitrary color image on the basis of each parameter; and
displaying, as a corrected image, an image obtained by correcting one of colors of the detected combination to each color-deficient person.

12. The color image processing method according to claim 11, wherein said correction is made in consideration of the degree to which the color-deficient person confuses the detected combination of colors and the degree to which one of the colors of the detected combination is corrected.

13. The color image processing method according to claim 12, wherein said correction is made so as to minimize the sum of the degree to which the color-deficient person confuses the detected combination of colors and the degree to which one of the colors of the detected combination is corrected.

14. The color image processing method according to claim 11, further comprising the steps of:
clustering colors in the arbitrary image into a plurality of color groups;
counting the number of pixels having a color to be corrected in each cluster; and
setting all of colors in a cluster having a predetermined ratio or higher of the number of the pixels as objects of said correction.

15. The color image processing method according to claim 11, wherein each parameter is derived by presenting a plurality of color images to each color-deficient person and obtaining data regarding ways the plurality of color images are seen by each color-deficient person.

16. A color image processing system comprising:
an input unit which receives a parameter for determining a combination of colors that can be distinguished by a person of normal color vision but cannot be distinguished by a color-deficient person, and an arbitrary color image;
a color warning control unit which detects the combination of colors that can be distinguished by the person of normal color vision but cannot-be distinguished by the color-deficient person in the arbitrary color image on the basis of the parameter and changes one of colors of the detected combination into a specific color; and
a display which displays, as a warning image, an image obtained by changing one of the colors of the detected combination into the specific color.

17. The color image processing system according to claim 16, wherein the color warning control unit clusters colors in the arbitrary color image into a plurality of color groups, counts the number of pixels having a color to be changed into the specific color in each cluster, and sets all of colors in a cluster having a predetermined ratio or higher of the number of the pixels as objects to be changed into the specific color.

18. A color image processing system comprising:
an input unit which receives a parameter for determining a combination of colors that can be distinguished by a person of normal color vision but cannot be distinguished by a color-deficient person, and an arbitrary color image;
a color correction control unit which detects the combination of colors that can be distinguished by the person of normal color vision but cannot be distinguished by the color-deficient person in the arbitrary color image on the basis of the parameter and corrects one of colors of the detected combination; and
a display which displays, as a corrected image, an image obtained by correcting one of the colors of the detected combination.

19. The color image processing system according to claim 18, wherein the color correction control unit makes said correction in consideration of the degree to which the color-deficient person confuses the detected combination of colors and the degree to which one of the colors of the detected combination is corrected.

20. The color image processing system according to claim 19, wherein the color correction control unit makes said correction so as to minimize the sum of the degree to which the color-deficient person confuses the detected combination of colors and the degree to which one of the colors of the detected combination is corrected.

21. The color image processing system according to claim 18, wherein the color correction control unit clusters colors in the arbitrary image into a plurality of color groups, counts the number of pixels having a color to be corrected in each cluster; and sets all of colors in a cluster having a predetermined ratio or higher of the number of the pixels as objects of said correction.

22. A color image processing system comprising:
a display which displays a color image to color-deficient persons;
a parameter control unit which derives respective parameters for determining a combination of colors that can be distinguished by a person in normal color vision but cannot be distinguished by a color-deficient person by obtaining data regarding a way the color image is seen by the respective color-deficient persons; and
a color warning control unit which detects the combination of colors that can be distinguished by the person in normal color vision but cannot be distinguished by the color-deficient person in an arbitrary color image on the basis of each parameter and changes one of colors of the detected combination into a specific color,
wherein a color image obtained by changing one of the colors of detected combination into the specific color is displayed as a warning image on the display.

23. The color image processing system according to claim 22, wherein the color warning control unit clusters colors in the arbitrary color image into a plurality of color groups, counts the number of pixels having a color to be changed into the specific color in each cluster, and sets all of colors in a cluster having a predetermined ratio or higher of the number of the pixels as objects to be changed into the specific color.

24. A color image processing system comprising:
a display which displays a color image to color-deficient persons;
a parameter control unit which derives respective parameters for determining a combination of colors that can be distinguished by a person in normal color vision but cannot be distinguished by a color-deficient person by obtaining data regarding a way the color image is seen by the respective color-deficient persons; and
a color correction control unit which detects the combination of colors that can be distinguished by the person in normal color vision but cannot be distinguished by the color-deficient person in an arbitrary color image on the basis of each parameter and corrects one of colors of the detected combination,
wherein a color image obtained by correcting one of the colors of the detected combination is displayed as a corrected image on the display.

25. The color image processing system according to claim 24, wherein the color correction control unit makes said correction in consideration of the degree to which the color-deficient person confuses the detected combination of colors and the degree to which one of the colors of the detected combination is corrected.

26. The color image processing system according to claim 25, wherein the color correction control unit makes said correction so as to minimize the sum of the degree to which the color-deficient person confuses the detected combination of colors and the degree to which one of the colors of the detected combination is corrected.

27. The color image processing system according to claim 24, wherein the color correction control unit clusters colors in the arbitrary image into a plurality of color groups, counts the number of pixels having a color to be corrected in each cluster, and sets all of colors in a cluster having a predetermined ratio or higher of the number of the pixels as objects of said correction.
